(19) United States
(12) Patent Application Publication
(10) Pub. No.: US 2005/0081386 A1
(43) Pub. Date: Apr. 21, 2005

(54) Scissors with precise control and labor-saving functions

(76) Inventor: Cheng-Cheng Chang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 10/687,640

(22) Filed: Oct. 20, 2003

(51) Int. Cl. B26B 3/06; B26B 13/00

(52) U.S. Cl. 30/151; 30/153; 30/162; 30/252

(57) ABSTRACT

The present invention is scissors with precise control and labor-saving functions. It is to accurately control shears and cooperate with extendable force-arms with double fulcrums to save labor. The present invention comprises: a pair of cutting portions with a pair of cutters, the cutters being connected pivotally; two handle portions having two handle rods with double fulcrums and interaction force-arms, the double fulcrums including two front fulcrums connecting and exactly controlling the cutting portions and two rear fulcrums pivotally located on two rear ends of two handle rods, the rear fuilcrums cooperating with an elastic member to let the handle rods restore; two sliding sleeves located on the handle portions and being extendable based on length demands to assist as handle rods. Therefore, the shears can be controlled easily and precisely.

### BACKGROUND OF THE INVENTION

Normally scissors are adapted to cut off objects that can be trimmed, such as trees in a garden, art products, hair, etc. Via skilled operators, trimmed objects are remodeled with a new appearance. Although scissors can be operated very easily, those trimmed objects, given the effect of modification, will absolutely depend on the skills and precision of the operators; moreover, a pair of scissors with convenience and precision of control is most important to the operator.

However, the present scissors in the market mainly include shears pivotally connected to each other with a pair of handles elongated from the two shears. By way of an operator's fingers going through the two holes of the handles, the scissors can then be operated. Such a structure is capable of reaching a trimming effect accordingly, but does not have a labor-saving and precise operating method for long-term scissor control. The premier factor is that the long distance between the hole of the handle and the shear hardly result in precise control. According to prior experience, to fabricate an art product or paper-cut product in elementary school may take a portion on each shear around a pivotal point of the scissors to have an easier and exact cut. Due to the long distance of the prior art having no constancy with accurate trimming, to shorten the long distance shall be the best way to avoid inconvenience to the operator.

The aforesaid structure of the prior art provides a short distance between a handle point and an application point; which means, the distance is only defined from the hole, through which the operator's finger moves, to the applied portion on the shear. Therefore, in a long-term consideration, that is a heavy load for the operator's fingers, especially to the fingers for cutting out thicker or harder material. That straightforwardly causes hand ache, and even more affects the following operation.

### SUMMARY OF THE INVENTION

The first objective of the present invention is to provide a short-distance arrangement for a handle portion, a front fulcrum and shears to cooperate with a rear fulcrum, thus forming an extendable handle force-arm with double fulcrums for labor-saving. The present invention provides the scissors with precise control and labor-saving functions, which is able to accurately control the scissors, and the scissors comprise: two cutting portions of cutting legs, which are for connection and control; a handle portion, which has two handle rods with double fulcrums, the double fulcrums include the aforesaid front fulcrum connecting and exactly controlling the cutting portions and aforesaid rear fulcrum is pivotally located on the rear ends of the handle rods, the rear fulcrum cooperates with an elastic member to let the handle rods restore; a sliding sleeve, which is located on the handle portion and can be extendable based on length demand to assist the handle rods. By way of a double-fulcrum structure of the front fulcrum and the rear fulcrum, the force-arm is then formed and provided to the handle portion for labor-saving, and the front fulcrum adjacent to the cutting portions is a key to make the control of the shears more precise; further, two long slots provided in two handles cooperate with the cutting portions connecting and sliding in the long slots and a sliding/receiving means of the front fulcrum of the handle portion to offer the cutting portion received in the handle portion or pushed out and positioned on a sliding/controlling means engaged by the front fulcrum.

### BRIEF DESCRIPTION OF THE DRAWINGS

FIG. 1 is a 3-D exploded sketch of a first preferred embodiment of the present invention.

FIG. 2 is an assembled structure sketch of the first preferred embodiment of the present invention.

FIG. 3 is a controlling sketch of the first preferred embodiment of the present invention.

FIG. 4 is a sketch of assisted handle rods of the first preferred embodiment of the present invention.

FIG. 5 is a 3-D exploded sketch of a second preferred embodiment of the present invention.

FIG. 6 is an assembled structure sketch of the second preferred embodiment of the present invention.

FIG. 7 is an operating sketch of receiving cutting portions of the second preferred embodiment of the present invention.

FIG. 8 is a sketch of a state of receiving cutting portions of the second preferred embodiment of the present invention.

FIG. 9 is a structure sketch of adding assistant handle rods of the second preferred embodiment of the present invention.

### DETAIL DESCRIPTION OF THE PREFERRED EMBODIMENTS

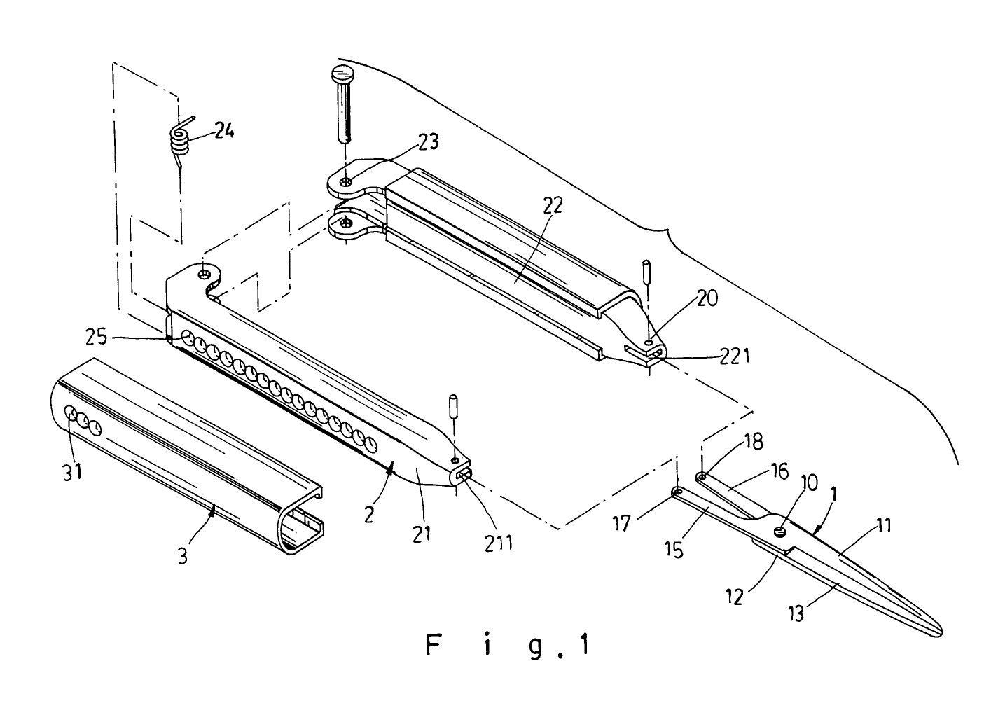

Please refer to FIG. 1 to FIG. 3, which are a 3-D exploded sketch of a first preferred embodiment of the present invention, an assembled structure sketch of the first preferred embodiment of the present invention and a controlling sketch of the first preferred embodiment of the present invention. The present invention mainly comprises: two cutting portions 1 for trimming; two handle portions 2, which include a double pivotal fulcrum set and connects the cutting portions 1 and two assistant handle rods 3, which extend from the handle portion 2 to form two controlling force-arms.

Referring to FIG. 1, a pair of cutters 11 and 12 with a pair of shears 13 and 14 are pivotally connected to each other, continuously, a pair of cutting tail-legs 15 and 16 with two holes 17 and 18 are elongated from a pivotal point 10 of the cutters 11 and 12 for connections and control of cutting portions 1 and handle portions 2.

ends of the cutting portions 1, and the handle rods 21 and 22 are made by metal or plastic via injection or extrusion ways. As shown in FIG. 1, two slots 211 and 221 are designed on two ends of the handle rods 21 and 22 to pivotally connect cutting tail-legs 15 and 16 for forming supporting interfaces of the handle portions 2 and the cutting portions 1 defined as front fulcrums 20. Two ends of the handle rods 21 and 22 being pivotally connected to each other therefore become another supporting interface of the handle portion 2 defined as a rear fulcrum 23. An elastic member 24 is set on a connecting point of the rear fulcrum 23, and the elastic member 24 is preferably a torsional spring to constantly keep the handle rods 21 and 22 open and provide restoring force while the handle rods 21 and 22 are pressed for trimming. A plurality of concave points 25 are placed in a series on two side surfaces of the handle rods 21 and 22 for assembling and positioning the assistant handle rods 3.

The front fulcrums 20 of the handle portions 2 assemble with the pivotal point 10 of the cutting portions 1 at a tiny distance for improving the accuracy of the handle portions 2 controlling the cutting portions 1. Meanwhile, to avoid heavier application force happening due to the short distance between the front fulcrum 20 and the pivotal point 10, the front and the rear fulcrums 20 and 23 cooperate with the handle rods 21 and 22 to become interaction applying force-arms to function as with a labor-saving feature.

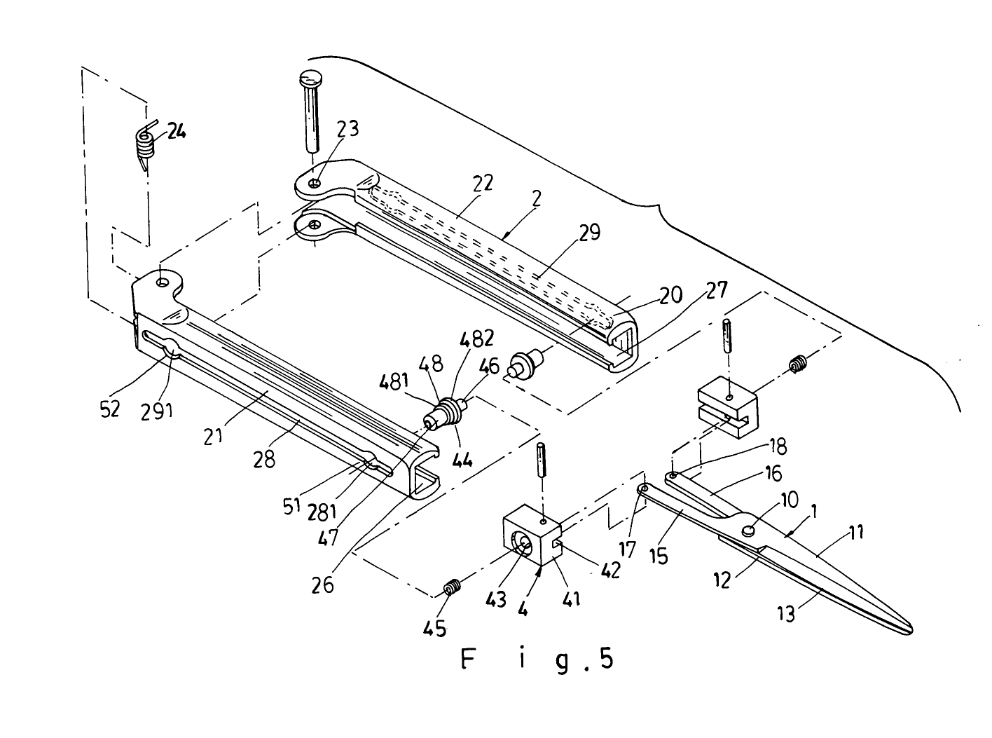

In the first preferred embodiment of FIG. 1 to FIG. 3, two assistant handle rods 3, shaped corresponding to the handle rods 21 and 22, directly put around the handle rods 21 and 22 and are able to be extendable along both the handle rods 21 and 22 based on the demands for extending applying force-arms of the handle rods 21 and 22. As shown in FIG. 4, which is a sketch of assisted handle rods of the first preferred embodiment of the present invention. Then, cutting portions 1 can be operated more in a more accurate and labor-saving manner. Further, a plurality of nodes 31 are grooved on two side surfaces of the assistant handle rods 3, and positions of the nodes 31 are corresponding to the concave points 25 of the handle rods 21 and 22.

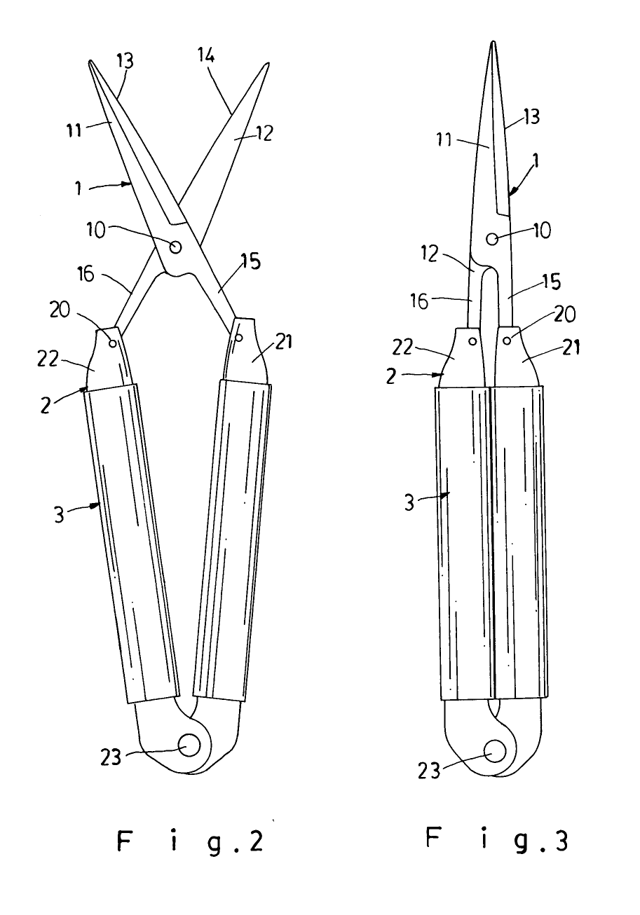

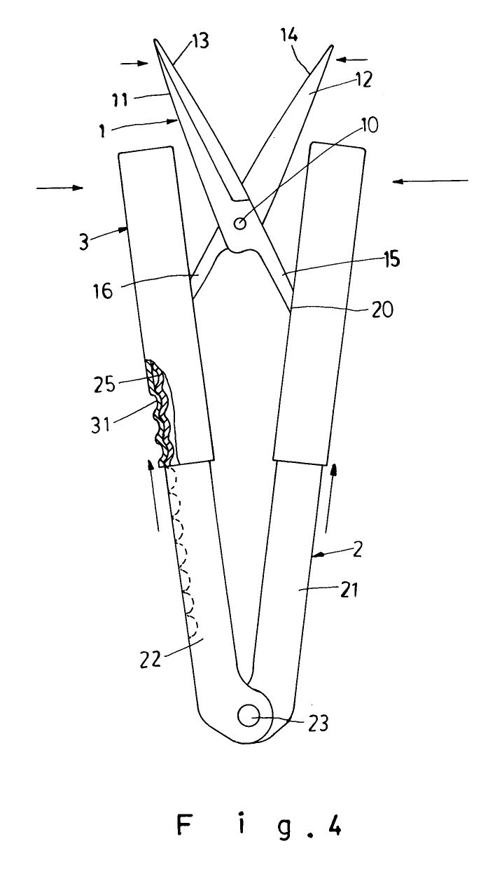

As shown in FIG. 2 and FIG. 3, the handle rods 21 and 22 applied by the elastic member 24 keep a status of opening as cutting portions 1. In FIG. 2, only directly applying a force onto the handle rods 21 and 22 may drive the pair of shears 13 and 14. In FIG. 3, a restored force generated by pressing the elastic member 24 lets the handle rods 21 and 22 and the shears 13 and 14 go back to their opening positions for the next pressing action. Since the front fulcrum 20 is very close to the pivotal point 10, the handle portions 2 can be more accurate to control the cutting portions 1 for trimming. On the other hand, the front and the rear fulcrums 20 and 23, cooperating with the handle rods 21 and 22, become interaction applying force-arms to function as the labor-saving feature. In FIG. 4, the applied forces by the handle portions 2 being capable of cooperating with the assistant handle rods 3 extended from the handle rods 21 and 22 shall approach the labor-saving purpose.

The structure of the present invention can be modified based on the spirit and scope of design. Referring to FIG. 5 to FIG. 9, which are a 3-D exploded sketch of a second preferred embodiment of the present invention, an assembled structure sketch of the second preferred embodiment of the present invention, an operating sketch of receiving cutting portions of the second preferred embodiment of the present invention, a sketch of a state of receiving cutting portions of the second preferred embodiment of the present invention and a structure sketch of adding assistant handle rods of the second preferred embodiment of the present invention. In the preferred embodiment, which further includes a sliding/receiving means 4. The sliding/receiving means 4 provides a function of the cutting portions 1 being received in the handling portions 2. It is then the safety of the second preferred embodiment being improved, and simultaneously the cutting portions 1 can be protected as well, professional scissors especially will need such protection.

In FIG. 5, the present embodiment mainly comprises: two cutting portions 1 for trimming; two handle portions 2, which include a double pivotal fulcrum set and connects the cutting portions 1, two assistant handle rods 3, which extend from the handle portion 2 to form two controlling force-arms and the sliding/receiving means 4.

Referring to FIG. 5, the same as the first preferred embodiment, a pair of cutters 11 and 12 with a pair of shears 13 and 14 are pivotally connected to each other, continuously, a pair of cutting tail-legs 15 and 16 with two holes 17 and 18 are elongated from a pivotal point 10 of the cutters 11 and 12 for connections and control of cutting portions 1 and handle portions 2.

Again, according to FIG. 5, except for the elastic member 24 being pivotally installed on the rear ends of the handle rods 21 and 22 to form the rear fulcrum 23 as the first embodiment, two long slots 26 and 27 are grooved on two comparative inner surfaces of the handle rods 21 and 22 for motion paths, therefore, the long slots 26 and 27 and the sliding/receiving means 4 provide the connection of the cutting portions 1 and the handle portions 2 and a room to receive the cutting portions 1. Two guiding slots 28 and 29 are established on two bottom surfaces of the long slots 26 and 27 to guide and automatically fix the sliding/receiving means 4 for forming a short control distance between the pivotal point 10 of the cutting portions 1 and the front fulcrum 20 of the handle portions 2. More, a plurality of concave points 25 are placed on two side surfaces of the handle rods 21 and 22 for assembling and positioning the assistant handle rods 3.

Positioning settings of the guiding slots 28 and 29 are a pushing positioning setting 51 and a receiving positioning setting 52 individually mounted on two side surfaces thereof, but not limiting the positions; on the contrary, only fitting the pushing positioning setting 51 may be a basic requirement. The pushing positioning setting 51 and the receiving positioning setting 52 are figured as two arc openings 281 and 291, the arc openings 281 and 291 are a little wider than the widths of the guiding slots 28 and 29 for positioning the sliding/receiving means 4 being pushed out and the cutting portions 1 being received.

The sliding/receiving means 4 further includes two joining bases 41 capable of sliding in the long slots 26 and 27. The joining bases 41 adopt the shapes relative to the long slots 26 and 27 for stable sliding. A fillister 42 is bedded in an inner surface of each joining base 41 to pivotally join a pair of cutting tail-legs 15 and 16 for constructing the connecting structure of the handle portions 2 and the cutting portions 1. An outer surface of each joining base 41 has an assembling hole 43. The assembling hole 43 may work together with an axis buckle 44 and an elastic member 45 to position and release.

The axis buckle 44 has a withstanding rod 46 comparative to the elastic member 45; a pressing rod 47, which is designed on another side of the axis buckle 44 and coaxial to the withstanding rod 46 and an axial rod 48, which is for positioning. The axial rod 48 provides a first axial rod 481 working with the arc opening 281, another first axial rod 481 working with the arc opening 291, and still, a second axial rod 482 a little larger than the first axial rod 481 is to limit the active scope of the axis buckle 44 working with the elastic member 45. It is to avoid the axis buckle 44 jumping out of the assembling hole 43 via the elastic member 45.

The two sliding/receiving means 4 have the following important functions: the first, providing the connection of the handle portions 2 and the cutting portions 1 to let the cutters 11 and 12 be controlled by the handle portions 2 for trimming; the second, offering the control means of receiving the cutting portions 1 in the handle portions 2 and pushing the cutting portions 1 out. Each axis buckle 44 with the elastic member 45 can handle the sliding operation, especially the operations of pushing and positioning and receiving after releasing positioning.

As the first preferred embodiment, two outer sides of the handles 21 and 22 of the handle portions 2 can be further added to two assistant handle rods 3, but the assistant handle rods 3 are not really necessary; on the other hand, the front and the rear fulcrums 20 and 23, cooperating with the handle rods 21 and 22, become interaction applying force-arms to function as the labor-saving feature. Two long slots 39 are designed on two side surfaces of the guiding slots 28 and 29 of the assistant handle rods 3 to make the first axial rods 481 go through the assistant handle rods 3 to easily receive the cutting portions 1.

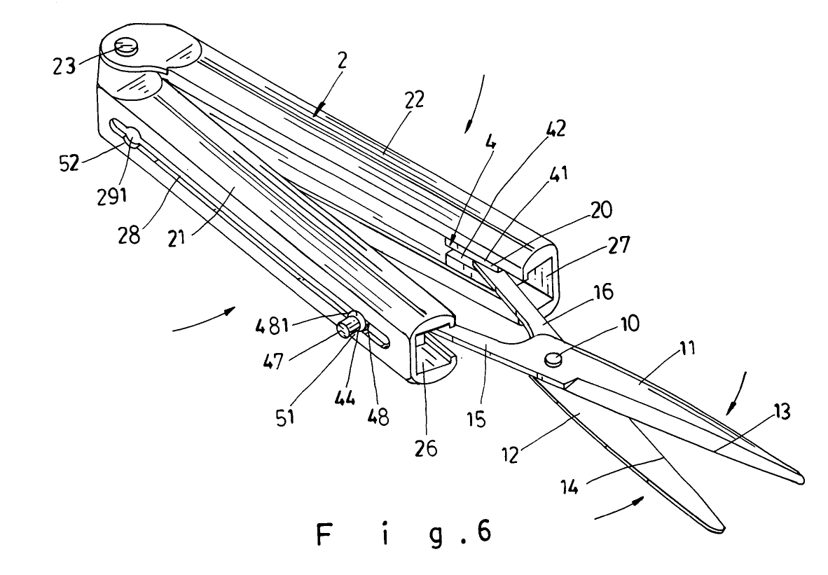

Referring to FIG. 6, the same as the first preferred embodiment, the double-fulcrum structure of the rear fulcrums 20 and 23 provide the handle portions 2 a handle force-arm with labor-saving function. Therefore, the handle rods 21 and 22 easily drive cutters 11 and 12 of the cutting portions 1, continuously, the elastic member 24 provides a restore force for the continuous operations of pressing and restoring, and the front fulcrum 20 adjacent to the cutting portions 1 makes the operations of the shears 13 and 14 more accurate.

For other functions, the handle portions 2 working together with the sliding/receiving means 4 supplies the protection, receiving, pushing and positioning for the cutting portions 1, shown as FIG. 6 to FIG. 9. The cutting portions 1, under the conditions of engaging without receiving and waiting to engage, can be fixed by way of that the sliding/receiving means 4 mounted on two handle rods 21 and 22 of the handle portions 2 working together with the elastic member 45 of the axis buckle 44 to have plural fixing positions for the first axis rod 481 automatically buckling on, such fixing positions being the arc openings 281 and 291 on the guiding slots 28 and 29, shown as FIG. 6.

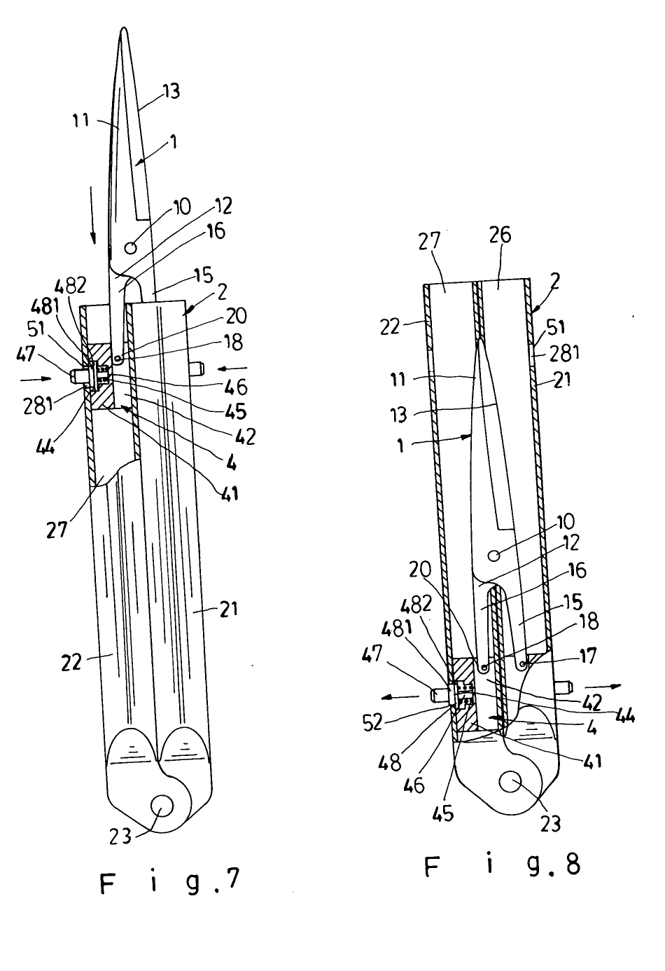

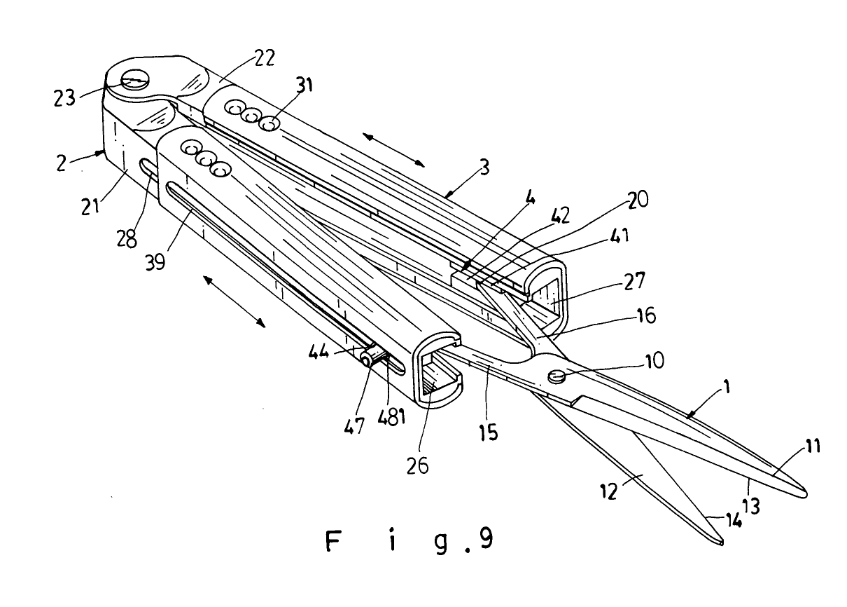

As shown in FIG. 7, firstly, to press the handle rods 21 and 22 and then the axis buckles 44 of the sliding/receiving means 4, secondly, the axial rods 48 is driven to let the first axial rod 481 work together with the elastic member 45 to be pressed inwardly. Thus, the first axial rod 481 takes off the arc openings 281 and 291 of the guiding slots 28 and 29 to release the sliding/receiving means 4 from the pushing positioning setting 51. As shown in FIG. 8, the sliding/receiving means 4 are driven by the guiding slots 28 and 29 via the pressing rods 47 and move toward the rear fulcrum 23 of the handle portions 2, hence, the cutting portions 1 are moved and received in the long slots 26 and 27 of the handle rods 21 and 22 of the handle portion 2. While the cutting portions 1 being completely received, that is, the sliding/receiving means 4 moving to the receiving positioning setting 52, the axis buckles 44 working together with the elastic members 45 automatically position in the arc openings 281 and 291 at the receiving positioning setting 52. As shown in FIG. 9, the cutting portions 1 are protected and do not sliding out while not in engagement.

To reuse the cutting portions 1, the only way to do this is to manually push the sliding/receiving means 4 or press the axis buckles 44 to release the first axial rods 481 at the receiving positioning settings 52, the sliding/receiving means 4 and the cutting portions 1 are pushed out of the handle portions 2 simultaneously. While approaching the pushing positioning settings 51, the elastic members 45 may automatically push the axis buckles 44 out via flexible force to let the first axial rods 481 buckle the arc openings 281 and 291 of the pushing positioning settings 51 up.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. Scissors with precise control and labor-saving functions comprising of:
a pair of cutting portions with a pair of cutters, the cutters being connected pivotally;
two handle portions having two handle rods with double fulcrums and interaction force-arms, the double fulcrums including two front fulcrums connecting and exactly controlling the cutting portions and two rear fulcrums pivotally located on two rear ends of two handle rods, the rear fulcrums cooperating with an elastic member to let the handle rods restore;
two sliding sleeves located on the handle portions and being extendable based on length demands to assist the handle rods.

2. The scissors with precise control and labor-saving functions as cited in claim 1, wherein a pair of cutters are pivotally connected to each other, a pair of cutting tail-legs with two holes are elongated from another side of a pivotal point for connections and control of cutting portions and handle portions.

3. The scissors with precise control and labor-saving functions as cited in claim 1, wherein two slots are designed on two ends of the handle rods to pivotally connect two cutting tail-legs for forming supporting interfaces of the handle portions and the cutting portions defined as front fulcrums.

4. The scissors with precise control and labor-saving functions as cited in claim 1, wherein a plurality of concave points are placed in a series on two side surfaces of the handle rods for assembling and positioning assistant handle rods.

5. The scissors with precise control and labor-saving functions as cited in claim 1, wherein an elastic member is set on a connecting point of the rear fulcrum, and the elastic member is preferably a torsion spring.

6. The scissors with precise control and labor-saving functions as cited in claim 1, wherein the front fulcrums of the handle portions are assembled with a pivotal point of the cutting portions in a tiny distance for improving accuracy of the handle portions controlling the cutting portions.

7. The scissors with precise control and labor-saving functions as cited in claim 1, wherein the front and the rear fulcrums cooperating with the handle rods become interactions applying force-arms to function as the labor-saving function.

8. The scissors with precise control and labor-saving functions as cited in claim 1, wherein two assistant handle rods, being shaped corresponding to the handle rods, directly put around the handle rods and are able to be extendable along both the handle rods based on demands for extending applying force-arms of the handle rods, a plurality of nodes 31 are grooved on two side surfaces of the assistant handle rods, and positions of the nodes are corresponding to plural concave points of the handle rods.

9. Scissors with precise control and labor-saving functions comprising of:
a pair of cutting portions with a pair of cutters, the cutters being connected pivotally;
two handle portions, two long slots being grooved on two comparative inner surfaces for motion paths of two sliding/receiving means and the cutting portions, two guiding slots being established on two bottom surfaces of the long slots to guide the sliding/receiving means, the handle portions including two front fulcrums and two rear fulcrums pivotally connecting two handle rods, the rear fulcrums working together with an elastic member to let handle rods restore;
the sliding/receiving means connecting the cutting portions and the handle portions provide to receive the cutting portions in the handle portions and to push and to position the cutting portions at the front fulcrums.

10. The scissors with precise control and labor-saving functions as cited in claim 9, wherein the guiding slots have plural pushing positioning settings located at the front ends of the guiding slots.

11. The scissors with precise control and labor-saving functions as cited in claim 10, wherein the pushing positioning settings are adjacent to a pivotal point of the cutting portions, and thus to cooperate with the sliding/receiving means to become front fulcrums.

12. The scissors with precise control and labor-saving functions as cited in claim 10, wherein the guiding slots have plural pushing positioning settings and plural receiving positioning settings located on the two sides thereof.

13. The scissors with precise control and labor-saving functions as cited in claim 12, wherein the pushing positioning settings and receiving positioning settings are arc shapes and wider than the widths of the guiding slots to offer positioning of pushing the sliding/receiving means out and receiving the cutting portions.

14. The scissors with precise control and labor-saving functions as cited in claim 9, wherein the sliding/receiving means further includes two joining bases, a fillister is bedded in an inner surface of each joining base to pivotally join a pair of cutting tail-legs, an outer surface of each joining base has an assembling hole, the assembling hole works together with an axis buckle and an elastic member to position and release.

15. The scissors with precise control and labor-saving functions as cited in claim 14, wherein the axis buckle has a withstanding rod comparative to the elastic member; a pressing rod 47 is designed on another side of the axis buckle and coaxial to the withstanding rod and an axial rod and is for positioning.

16. The scissors with precise control and labor-saving function as cited in claim 15, wherein the axial rod provides a first axial rod working with an arc opening, another first axial rod working with another arc opening, and still, a second axial rod a little larger than the first axial rod is to limit an active scope of the axis buckle working with the elastic member, it is to avoid that the axis buckle jumps out of the assembling hole via the elastic member.

17. The scissors with precise control and labor-saving functions as cited in claim 9, wherein two outer sides of the handles of the handle portions can be further added two assistant handle rods, a plurality of nodes are grooved on two side surfaces of the assistant handle rods, two long slots corresponding to two end surfaces of the guiding slots are installed on the assistant handle rods for controlling axis buckles of the sliding/receiving means and pushing the cutting portions out.
